(19) United States
(12) Patent Application Publication
(10) Pub. No.: US 2021/0308694 A1
(43) Pub. Date: Oct. 7, 2021

(54) CLAWSON-IMPROVED FLOTATION VALVE

(71) Applicant: Freeport-McMoRan Inc., Phoenix, AZ (US)

(72) Inventors: Lloyd Clawson, Phoenix, AZ (US); Enrique Holguin, Phoenix, AZ (US); Steven Mariscal, Phoenix, AZ (US)

(21) Appl. No.: 16/839,342

(22) Filed: Apr. 3, 2020

(51) Int. Cl. B03D 1/02; B03D 1/14; F16K 31/20

(52) U.S. Cl. CPC B03D 1/028; B03D 1/1406; B03D 2203/02; F16K 31/20; B03D 1/1487

(57) ABSTRACT

A dart valve is mounted in a modular cartridge that may be replaced as a unit within a junction box without necessarily having to stop a froth flotation process that is underway. A plurality of these modular cartridges may be placed within a single junction box.

### BACKGROUND

### Field of the Invention

The presently described instrumentalities pertain to flow control valves of the type used in froth flotation processing and processing that is closely related to froth flotation.

### Description of the Related Art

Froth flotation is a well-known separation technology that takes advantage of differences in hydrophobicity of materials to implement a separation strategy. Significant applications for use of froth flotation exist, for example, in mineral processing, waste water treatment, and paper recycling. Mineral processes are used to separate valuable minerals from gangue and may be utilized on a wide variety of ores ranging from sulfides, carbonates, and oxides. Other mineral products, such as phosphates and coal, may be upgraded by use of flotation technologies. Plants performing this operation are frequently known in the art as concentrators or mills.

In froth flotation processes for separation of metals from ore, the metals are liberated by comminution, which entails crushing and grinding of ore until individual minerals exist as separate grains. The particle sizes for this may range, for example, from 0.1 mm at a high end down to smaller than 10 sm. Smaller particle sizes are generally necessary as mining regions mature and the quality of ore degrades.

The liberated ore is mixed with water for form a slurry, which is sometimes called a pulp. Various chemicals may be added, most frequently surfactants as are known to the art on an ore-specific basis for purposes of rendering the ore hydrophobic. Other chemicals may be added, such as frothing agents, to facilitate retention of valuable metal or other mineral particles during ore separation. The pulp may be agitated with injection of air bubbles that, in the case of metals separation, avail the principles of interfacial tension as are known to the art in lifting valuable metal ‘float’ while less valuable minerals sink The particles that sink in this process are known as flotation tailings or tails. Either the float or the tails may be processed in a first flotation cell and subsequently scavenged by re-processing in a series of subsequent flotation cells to enhance the efficiency of mineral recovery. The float from a particular stage by be reground and recycled through all or part of the flotation system.

Industry practices have been to connect a plurality of flotation cells together in banks of adjacent units with a hog-through discharge from one unit to the next. Step-down junction boxes are provided for level control in connecting one bank in series to the next. The junction boxers contain valves, such as dart valves, that maintain level control of the various banks in this type of system. In the past, when is was more common to use smaller rectangular boxes for flotation cells, there was much debate about the best way to group these boxes for connection in series. More recent practices include using larger cylindrical cells that require fewer groups of connected cells. This is shown in U.S. Pat. No. 5,205,926, which is incorporated herein by reference to the same extent as though fully replicated herein. FIGS. 2 and 3 of U.S. Pat. No. 5,205,926 show, by way of example, a junction box 108 connecting banks comprised of groupings of cells 53 and 57. Each individual cell contains a central rotor, such as rotors 62, 63, providing mechanical agitation while injecting bubbles to be utilized in mineral separation. The cells are grouped in banks where each of the banks contain a plurality of cells. The junction box 108 receives unfloated slurry from the bottom of bank 53 and transfers this to bank 57. Flow control is implemented through the use of valves in the junction box in which the control of liquid from bank 53 and to bank 57 is governed by one or more valves in the junction box 108. valve allocated to each cell on a one-to-one basis. This is usually done in an open configuration such that the valves in the junction box 108 are the sole means of fluidically communicating and isolating bank 53 from bank 57. Similar junction boxes are also shown in U.S. Pat. No. 5,965,857 to Hughes.

In this type of flotation process, one bank of cells is deployed to precede another bank as the pulp/slurry is serially processed in stages to increase the overall recovery efficiency of valuable metals. The various flotation stages may include, for example, an optional pre-flotation stage that removes particles which naturally float, followed by roughing to remove large particles, and then scavenging in successive stages. The cells of each stage may collect the froth which, generally speaking, overflows a weir and is further concentrated in a collection box that is sometimes called a launder. The final tailings are disposed of as fill, or they may be placed in disposal facilities for long term storage.

A similar type of gravity based minerals separation system may or may not utilize froth, and is essentially an extraction system to collect valuable leachate in an organic phase as described in U.S. Pat. No. 6,315,899 to Hernandez.

Valves utilized in the junction boxes are frequently of the class known as dart valves. These valves have an upright rod that leads to a generally frustoconical valve component which seats tapering up against a valve seat. Lowering the valve component with respect to the valve seat opens a passageway for the flow of liquid in the flotation cell. U.S. Pat. No. 6,453,939 to Cook and Hunt shows, by way of example, a flotation cell with utility in oil, wastewater, treatment, pulp and paper, mining and mineral reclamation applications. A valve is used to maintain the liquid level in the tank within a specified range. If the liquid level is too low, then the separated mineral concentrate or float will not overflow into the launder at a suitable rate. Residence time is thereby increased with concentrates sinking back into the tail, which decreases the recovery efficiency of the separation process. A level that is too high is problematic in the sense of submitting unnecessary overflow to the launder while also potentially causing flotation losses.

The valves eventually wear out. United States Patent Publication 2017/0036219 to Peasely et al. describes a system for monitoring wear on the valves an other components. The system provides early diagnosis of wear, making it possible to mitigate flotation losses by conducting maintenance at times when system downtime may be avoided.

The maintenance itself can be problematic. It may be necessary to shut down an entire bank of flotation cells while the row of valve boxes is drained for maintenance of one or more valves. Where the cells cannot otherwise be fluidically isolated, it may be further necessary to drain fluid from one or more of the cells in a bank, just to replace a single valve in the junction box. This creates a domino effect with significant productivity losses, especially in situations where a plurality of banks are arranged in series.

### SUMMARY

The presently disclosed instrumentalities advance the art and overcome the problems outlined above by providing a valve cartridge module for use such that an individual valve in a row of valves in a junction box boxes may now be replaced without having to drain the entire row and one or more cells that cannot be fluidically isolated from the junction box. A module of this type advantageously permits replacement of a worn valve without draining components of the flotation processing system even when, for example, one or more flotation cells are in open flow configuration with respect to the junction box. It is now, therefore, possible to continue uninterrupted with flotation separation processing while a valve is replaced.

According to one embodiment of the presently disclosed instrumentalities, a cartridge module system for use in a junction box for flotation processing contains a cartridge module formed of a dart valve system and a support frame. The dart valve system has a plunger, a rod connected to the plunger for actuation thereof, and a control mechanism for selective actuation of the rod. The support frame has a top and a bottom. The bottom of the support frame includes a seat aperture with dimensions complementary to those of the plunger for controlling flow of material passing thorough the seat by virtue of the position of the plunger relative to the seat aperture as provided by operation of the control mechanism. The top of the support frame retains the control mechanism of the dart valve system. A means is provided for mounting and demounting the cartridge in the junction box for selective sealing engagement therewith when the cartridge module is selectively installed in the junction box. This means includes, for example, a system of bolts, a system of clamps, or a gasket in combination with a weight of the cartridge module.

In one aspect, the support frame may be rectilinear.

In one aspect, the configuration of the cartridge module is such that positioning of the plunger relative to the seat increases an area available to flow of the material when the plunger is raised with respect to the seat aperture. Alternatively, the configuration may be such that the area available to flow decreases when the plunger is raised with respect to the seat aperture.

In various embodiments, the cartridge module as described above may be a component of a larger cartridge module system, such as a flotation processing system. By way of example, cartridge module may be mounted in sealing engagement with a junction box, and plurality of such modules may be mounted in a single junction box. In still larger cartridge module systems, the junction box may be mounted between a first bank including at least one first flotation cell and a second bank including at least one second flotation cell.

In one aspect, there may be optionally provided also a fluid level control system that selectively positions the plunger relative to the seat aperture to maintain a fluid level withi8n the first flotation cell within a predetermined range. This fluid level control system may, for example, include a float for sensing the fluid level in the first floatation cell, the float being configured to emit a signal representative of the fluid level for use in automated control of the fluid level when the fluid level is outside of the predetermined range.

The foregoing instrumentalities may be utilized in a method of flotation separation processing. This method entails forming a slurry of ore that has been comminuted to liberate metal. The slurry is introduced to a first flotation cell where separation of the metal is performed while maintaining a level of fluid in the cell within the predetermined range. This process of separation is performed until a first cartridge module is due for replacement. The first cartridge module is selectively demounted from the junction box, and a renewal cartridge is mounted in place of the first cartridge module. Thereafter, flotation separation is performed as before. continuing to perform separation of metal in the first flotation cell.

In one aspect, the steps of selectively demounting and mounting the first and renewal cartridge modules may be performed without interrupting the step of performing separation. This may also happen without necessarily having to drain the junction box or the first flotation cell, when the first flotation cell is in open flow configuration with respect to the junction box.

### BRIEF DESCRIPTION OF THE DRAWINGS

FIG. 1 is an assembly view of a cartridge module system according to one embodiment;

FIG. 2 shows the assembled ca cartridge module system in use during froth flotation;

FIG. 3 is a midsection view of the cartridge module system in use; and

FIG. 4 shows a process of utilizing the cartridge module according to one embodiment.

### DETAILED DESCRIPTION

The instrumentalities described above are shown in more detail below using of drawings and discussion thereof to teach by way of nonlimiting example.

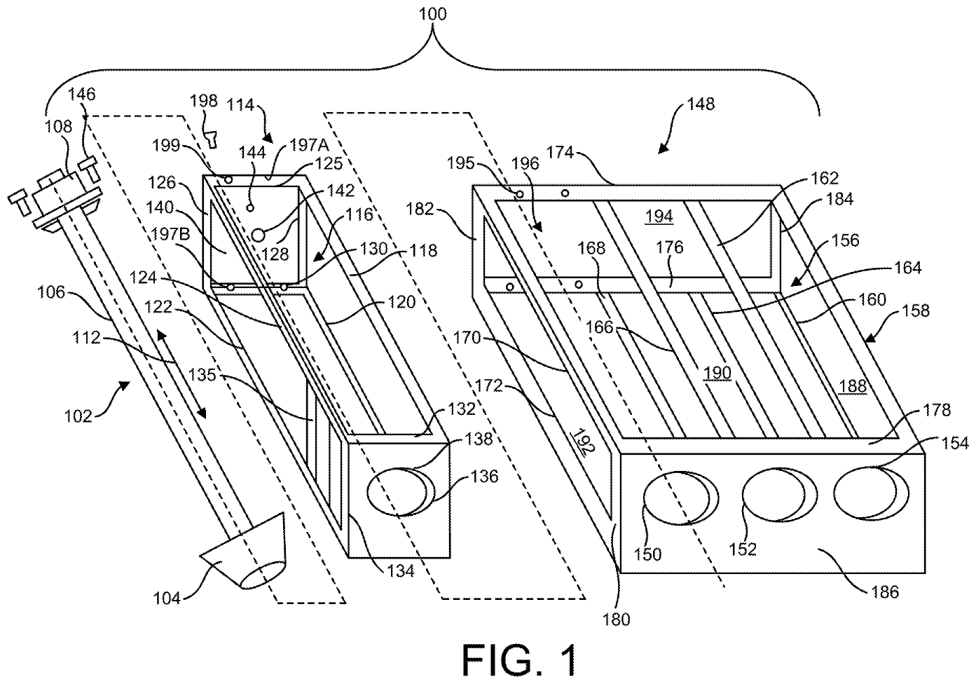

FIG. 1 is an assembly view 100 of a cartridge module system 100. A dart valve 102 is of a type that is commonly used in ore flotation or leaching processes and, by way of example, may be purchased on commercial order from eDart of Cape Town South Africa. The dart valve 102 includes a plunger 104 and a rod 106 connecting the plunger 104 with a dart actuator 108. The plunger 104 is shown assembled in a frustoconical shape tapering down, but in some embodiments I will be appreciated that the valve may be assembled in a frustoconical orientation (not shown) tapering up. When assembled, the dart actuator 108 is capable of causing the rod 106 to engage in axial shifting motions 112.

The dart actuator 108 may be removed so that the dart valve 102 may be reassembled to form a module 114 where the dart valve 102 resides in a rectilinear support frame 116 made of vertical upright channels 118, 120, 122, 124 and horizontal channels 125, 126, 128, 130, 132, 134, 135. A baseplate 136 provides an aperture that serves as a valve seat 138 for sealing engagement with the plunger 104. A top plate 140 defines an aperture 142 for receipt of the rod 106. The dart actuator 108 bolts to the top plate 140, for example, where an internally threaded hole 144 receives bolt 146.

A junction box 146, as shown in FIG. 1, is a valve housing that is constructed to receive three of the cartridge modules 114 sitting side by side. As shown in FIG. 1, the cartridge module 114 is received within the junction box 148 such that the aperture 142 is concentrically positioned with respect to opening 150. Additional cartridge modules identical to the cartridge module 114 are provided such that the valve seats 138 are proximate openings 152, 154. The junction box 148 may be constructed to receive any number of modular cartridges 114. The junction box 148 is constructed using an internal rectilinear frame 156 made of vertical posts 158, 160, 162, 164, 166, 168, 170, 172 and horizontal members 174, 176, 178, 180, 182, 184. A base plate 182 welded to the members 178, 180 defines the openings 150, 152, 154.

As depicted in FIG. 1, the rectilinear frame 156 is without an exterior skin that forms a watertight barrier at surfaces 188, 190, 192, 194, except for an inlet (not shown) permitting slurry to enter an internal reservoir 196. Also, the top plate 140 may be provided with wings 197A, 197B including apertures, for example aperture 199, such that a bolt 198 may align with internally threaded aperture 195 on member 174 for mounting and demounting the cartridge 114 in the junction box 148 for engagement therewith when the cartridge module is installed in the junction box 148. Alternatively, a clamping or system (not shown) or system of latches such as bayonet latches may be utilized for this purpose.

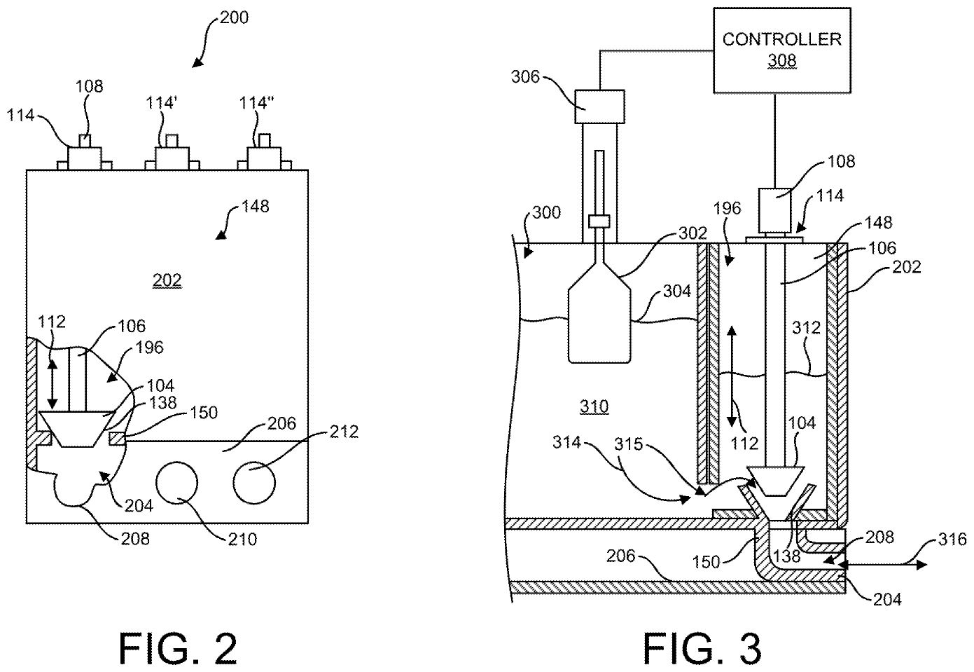

FIG. 2 shows the junction box 148 with a plurality of cartridge modules 114, 114′, 114″ assembled in place. A plate 202 forms part of the outer skin, as described above, and is welded to frame members 158, 162, 166, 170, 174, 178 to define in part the reservoir 196. As shown in FIG. 2, the dart valve actuator 108 is able to control gravity flow of slurry from the reservoir 196 by shifting 112 the rod 106 up and down for movement of the plunger 104 relative to seat 138. The seat 138 discharges through opening 150 into a plenum 204 within header 206 that is drained through orifices 208, 210, 212.

FIG. 3 is a midsection view of the junction box 148 with the cartridge module 114 installed proximate a flotation cell 300. The flotation cell 300 may be, for example, a flotation cell of the prior art as described above. A float 302 rises and falls with a liquid level 304 within the flotation cell 300. A housing 306 with sense circuitry provides a signal, such as a voltage, current, or wireless signal, to controller 308 which, in turn, communicates with the dart valve actuator 108 for shifting movement 112 of rod 106 that repositions the plunger 104 relative to the valve seat 138. This creates a different level 312 within reservoir 312 because of a pressure difference by virtue of hydrostatic head that is compensated by flow restriction between the plunger 104 and the valve seat 138. The reservoir 196 is in open flow configuration with the interior 310 of the floatation cell 300 such that inflow 314 enters reservoir 196 through opening 315 and discharges through the valve seat 138 and opening 150 into plenum 208 mand exits through opening 204. The outflow 314 may be used to feed a second float cell (not shown) in series.

The cartridge module 114 described above will be subjected to wear in the intended environment of use, and that such wear may continue until such time as the system is unable to maintain a suitable level 304 within the flotation cell 300. The foregoing instrumentalities improve prior systems by providing a cartridge module 114 that may be removed while a froth flotation process is underway. The cartridge module 114 may be advantageously replaced without having to drain the interior 310 of the flotation cell 300. In prior systems, drainage was necessary and time consuming due to the preferred open flow configuration through opening 315.

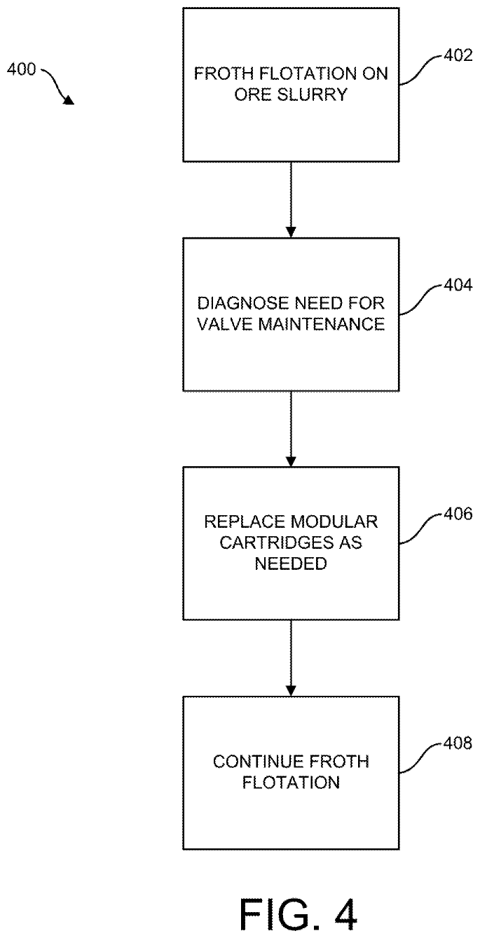

This is shown in FIG. 4 as process 400. Step 402 entails an ordinary froth flotation process where comminuted ore is subjected to froth flotation processing for purposes of isolating liberated metal particles. The process continues until a diagnosis 404 is made that there is a need for dart valve replacement. This may be made, for example, on the basis of a predetermined maintenance interval or on the basis that positioning of the plunger 104 is unable to maintain level 304 within a predetermined range as shown in FIG. 3. While the froth flotation process continues underway the cartridge module 114 is detached from the junction box 148 and replaced 406. The froth flotation process continues 408 uninterrupted throughout all of these steps.

Those of ordinary skill in the art will understand that the foregoing discussion teaches by way of example and not be limitation. Accordingly, what is shown and described may be subjected to insubstantial change without departing from the scope and spirit of invention. The inventors hereby state their intention to rely upon the Doctrine of Equivalents, if needed, in protecting their full rights in the invention.

We claim:

1. A cartridge module system for use in a junction box for flotation processing, comprising
a cartridge module including
a dart valve system and
a support frame
the dart valve system having
a plunger,
a rod connected to the plunger for actuation thereof, and
a control mechanism for selective actuation of the rod;
the support frame having a top and a bottom,
the bottom including a seat aperture with dimensions complementary to those of the plunger for establishing follow control of material passing thorough the seat by virtue of the position of the plunger relative to the seat aperture as provided by operation of the control mechanism,
the top retaining the control mechanism of the dart valve system; and
means for mounting and demounting the cartridge in the junction box for engagement therewith when the cartridge module is installed in the junction box.

2. The cartridge module system of claim 1, wherein the support frame is rectilinear.

3. The cartridge module system of claim 1, wherein the positioning of the plunger relative to the seat increases an area available to flow of the material when the plunger is raised with respect to the seat aperture.

4. The cartridge module system of claim 1, wherein the positioning of the plunger relative to the seat decreases an area available to flow of the material when the plunger is lowered with respect to the seat aperture.

5. The cartridge module system of claim 1, further comprising cartridge module system mounted in sealing engagement with the junction box.

6. The cartridge module of claim 5, wherein the means for mounting and demounting includes a system of one or more bolts.

7. The cartridge module of claim 5, wherein the means for mounting and demounting includes a system of one or more clamps.

8. The cartridge module of claim 5, wherein the means for mounting and demounting includes a gasket at the bottom of the support frame and a weight of the cartridge module.

9. The cartridge module system of claim 5, further comprising a plurality of the cartridge modules mounted in sealing engagement with the junction box.

10. The cartridge module system of claim 5, wherein the junction box is mounted between a first bank including at least one first flotation cell and a second bank including at least one second flotation cell.

11. The cartridge module system of claim 10, further comprising a fluid level control system that selectively positions the plunger relative to the seat aperture to maintain a fluid level withi8n the first flotation cell within a predetermined range.

12. The cartridge module system of claim 11, wherein the fluid level control system includes a float for sensing the fluid level, the float being configured to emit a signal representative of the fluid level for use in automated control of the fluid level when the fluid level is outside of the predetermined range.

13. A method of flotation separation processing by use of the cartridge module system as set forth in claim 5, the method comprising the steps of:
forming a slurry of ore that has been comminuted to liberate metal;
introducing the slurry to a first flotation cell;
performing separation of the metal in the first flotation cell during which separation a level of fluid in the cell is maintained within the predetermined range, the process of separation being performed until a first cartridge module is due for replacement;
selectively demounting the first cartridge module from the junction box; and
mounting a renewal cartridge in place of the first cartridge module; and
thereafter continuing to perform separation of metal in the first flotation cell.

14. The method of claim 13, wherein the steps of selectively demounting and mounting are performed without interrupting the step of performing separation.

15. The method of claim 14, wherein the steps of selectively demounting and mounting are performed without draining the junction box.

16. The method of claim 15, wherein the junction box is in open flow configuration with respect to the junction box and the steps of selectively demounting and mounting are performed without draining the first flotation cell.

17. The method of claim 13, wherein the steps of selectively demounting and mounting are performed without draining the junction box.

18. The method of claim 17, wherein the junction box is in open flow configuration with respect to the junction box and the steps of selectively demounting and mounting are performed without draining the first flotation cell.
